(19) United States
(12) Patent Application Publication
(10) Pub. No.: US 2025/0270077 A1
(43) Pub. Date: Aug. 28, 2025

(54) MOTOR MOVEMENT IN AN AIR HANDLER OF A CLIMATE CONTROL SYSTEM

(71) Applicant: Trane International Inc., Davidson, NC (US)

(72) Inventors: Joseph J. Fiegen, Onalaska, WI (US); Erick Couch, Nicholasville, KY (US); Joseph Stewart, Lexington, KY (US); Scott Luebbehusen, Lexington, KY (US)

(21) Appl. No.: 18/584,161

(22) Filed: Feb. 22, 2024

(51) Int. Cl. B66D 1/42; B66D 1/30

(52) U.S. Cl. CPC B66D 1/42; B66D 1/30; B66D 2700/0116; B66D 2700/0191

(57) ABSTRACT

An embodiment of a method of moving a motor within an enclosure of an air handler of a climate control system includes (a) suspending the motor from a first lifting support and a second lifting support via lifting line, the first lifting support being laterally spaced from the second lifting support in the enclosure. In addition, the method includes (b) shortening the lifting line extending between the motor and the second lifting support. Further, the method includes (c) lengthening the lifting line extending between the motor and the first lifting support. Still further, the method includes (d) moving the motor laterally within the enclosure as a result of (b) and (c).

### CROSS-REFERENCE TO RELATED APPLICATIONS

Not applicable.

### BACKGROUND

Climate control systems may cool or heat a conditioned space by use of a refrigerant circuit. Specifically, the climate control system may heat or cool the conditioned space by heating or cooling, respectively, an airflow with the refrigerant circuit (e.g., directly and/or via another thermally coupled fluid or circuit), and then circulating the heated or cooled airflow throughout the conditioned space.

In climate control systems for large buildings (e.g., such as office or industrial buildings, retail stores, etc.), the airflow maybe heated or cooled in an enclosed air handler and then supplied to the conditioned space from the air handler via ducting. Air handler may include enclosures that house one or more fan motors for driving airflow through the air handler during operations.

### BRIEF SUMMARY

Some embodiments disclosed herein are directed to methods of moving a motor within an enclosure of an air handler of a climate control system. In some embodiments, a method includes (a) suspending the motor from a first lifting support and a second lifting support via lifting line, the first lifting support being laterally spaced from the second lifting support in the enclosure. In addition, the method includes (b) shortening the lifting line extending between the motor and the second lifting support. Further, the method includes (c) lengthening the lifting line extending between the motor and the first lifting support. Still further, the method includes (d) moving the motor laterally within the enclosure as a result of (b) and (c).

In some embodiments, a method includes (a) lifting the motor off of a motor base in the enclosure with a first lifting line that is connected to a first lifting support in the enclosure. In addition, the method includes (b) connecting the motor to a second lifting support with a second lifting line after (a), wherein the second lifting support is laterally closer to an access door of the enclosure than the first lifting support. Further, the method includes (c) lengthening the first lifting line between the motor and the first lifting support and (d) shortening the second lifting line between the motor and the second lifting support. Still further, the method includes (e) laterally moving the motor toward the access door as a result of (c) and (d).

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those having ordinary skill in the art upon reading the following detailed description, and by referring to the accompanying drawings. It should be appreciated that this disclosure may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various embodiments, reference will now be made to the accompanying drawings in which:

FIG. 1 is a schematic, overhead view of a climate control system illustrating an air handler according to at least some embodiments disclosed herein;

FIG. 2 is a schematic, overhead view of a climate control system illustrating another air handler according to at least some embodiments disclosed herein;

FIGS. 3A-3G are sequential, side views of a process of moving a motor within the enclosure of the air handler of FIG. 1 or 2 according to some embodiments disclosed herein;

FIGS. 4A-4C are sequential, side views of a process of moving a motor within the enclosure of the air handler of FIG. 1 or 2 according to some embodiments disclosed herein;

FIG. 5 is a side view of a come along that may be used to shorten or lengthen a lifting line in the processes of FIGS. 3A-3G or 4A-4C according to some embodiments disclosed herein;

FIG. 6 is a side view of a chain winch that may be used to shorten or lengthen a lifting line in the processes of FIGS. 3A-3G or 4A-4C according to some embodiments disclosed herein;

FIG. 7 is a schematic view of a motorized system for shortening or lengthening a lifting line in the processes of FIGS. 3A-3G or 4A-4C according to some embodiments disclosed herein;

FIG. 8 is a schematic view of another motorized system for shortening or lengthening a lifting line in the processes of FIGS. 3A-3G or 4A-4C according to some embodiments disclosed herein;

FIG. 9 is a side view of tapered wheels for paying lifting line in the processes of FIGS. 3A-3G or 4A-4C according to some embodiments disclosed herein;

FIGS. 10(a) and 10(b) are sequential views showing lifting line paid in and paid out from the tapered wheels of FIG. 9 during the processes of FIGS. 3A-3G or 4A-4C according to some embodiments disclosed herein;

FIG. 11 is a schematic view of a motorized system for moving a motor between two lifting supports that may be used in the processes of FIGS. 3A-3G or 4A-4C; and

FIGS. 12 and 13 are block diagrams of methods of moving a motor within an enclosure of an air handler according to some embodiments disclosed herein.

### DETAILED DESCRIPTION

An air handler for a climate control system may include an enclosure that houses one or more fan motors therein. The enclosure may also form or define at least a portion of the airflow path of the air handler for ultimately supplying the conditioned (e.g., heated or cooled) airflow to the conditioned space during operations with the climate control system. As such, operating space within the enclosure may be limited so that movement of the fan motor(s) (e.g., into or out of the enclosure) may be difficult. Also, the fan motor(s) within the enclosure and an air handler may be heavy (e.g., reaching about 500 lbs. in some cases), which may further complicate movement of the fan motor(s) within the tight space of the enclosure. Moreover, the construction of complex lifting and maneuvering systems within an air handler enclosure may be unfeasible (e.g., due to cost, complexity).

Accordingly, embodiments disclosed herein include systems and methods for moving safely and efficiently moving a fan motor within the confined space of an enclosure of an air handler of a climate control system. In some embodiments, the systems and methods described herein may include controlled and coordinated lengthening and shortening of lengths of lifting lines connected to laterally spaced lifting supports within the enclosure so as to laterally traverse and maneuver the fan motor while minimizing uncontrolled movements (e.g., swinging). Thus, through use of the embodiments disclosed herein, a fan motor may be efficiently and safely moved about the limited space of an enclosure of climate control system air handler module with minimal additional infrastructure.

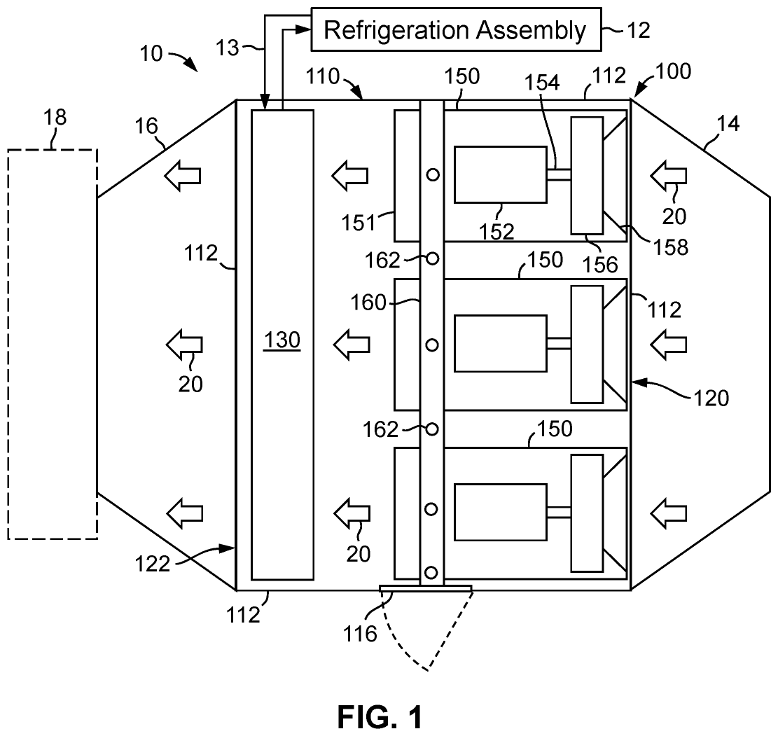

Referring now to FIG. 1, a climate control system 10 including an air handler 100 is shown according to some embodiments. The climate control system 10 may be configured to heat or cool a conditioned space 18 via an airflow 20 that is supplied to the conditioned space 18 during operations. The conditioned space 18 may include an interior of a relatively large, commercial building, such as an office building, retail store, industrial or manufacturing facility, sports facility, etc. Thus, the climate control system 10 may be configured to condition relatively large interior spaces/volumes and may, in some embodiments, be a chiller unit or other climate control system with a sufficiently large cooling/heating capacity for conditioning such larger spaces/volumes during operations.

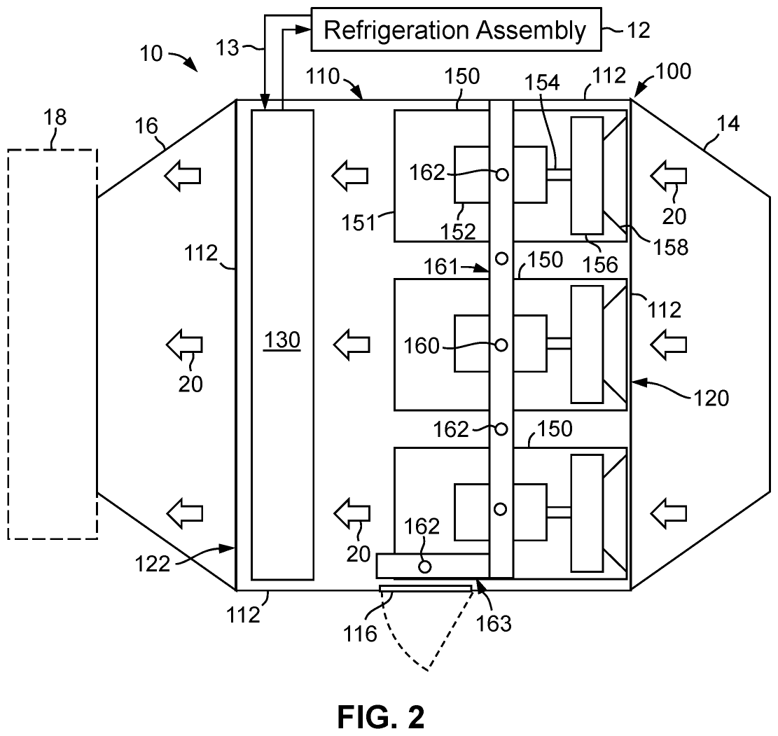

The air handler 100 generally includes an enclosure 110 having a plurality of vertically oriented walls 112, as well as a ceiling and floor (not shown in FIG. 1, but see ceiling 114 and floor 115 depicted in FIGS. 2A-2G). The enclosure 110 may include an access door 116 that may allow personnel to enter the enclosure 110 (e.g., such as during maintenance and/or installation operations).

An inlet 120 may be positioned along one of the walls 112 that is configured to direct the airflow 20 into the enclosure 110 during operations. An outlet 122 is defined on another wall 112 (a different wall 112 from that associated with the inlet 120) of the enclosure 110. In some embodiments, the enclosure 110 may be generally rectangular in shape (e.g., such as a rectangular parallelepiped) such that the inlet 120 and outlet 122 are positioned on opposite (or opposing) parallel walls 112 of the enclosure 110 such as shown in FIG. 1.

The inlet 120 may include one or more filters (not shown) for removing at least some particulates (e.g., dust, or other particulates) from the airflow 20 prior to entering enclosure 110. The inlet 120 may receive the airflow 20 from suitable ducting 14. In some embodiments, the airflow 20 may be at least partially recirculated from the conditioned space 18. In addition, at least some of the airflow 20 may be sourced or provided from an ambient environment, such as the outdoor environment surrounding the building or structure forming or defining the conditioned space 18.

A heat exchanger 130 (which may comprise one or a plurality of heat exchangers) may in fluid communication with the enclosure 110. For instance, in some embodiments (such as is shown in FIG. 1), the heat exchanger 130 may be positioned in the enclosure 110, proximate or adjacent to the outlet 122. In some embodiment, the heat exchanger 130 may be positioned in a separate enclosure (not shown) that is downstream of the enclosure 110. In either case (e.g., whether heat exchanger 130 is positioned in the enclosure 110 or not), the heat exchanger 130 may be in fluid communication with the enclosure 110 so that the airflow 20 may eventually contact the heat exchanger 130 during operations.

The heat exchanger 130 may receive a flow of heat transfer fluid 13 from a refrigeration assembly 12 so that during operations, the heat exchanger 130 is configured to facilitate the transfer of heat between the heat transfer fluid 13 and the airflow 20 to thereby cool or heat the airflow 20. For instance, in some embodiments, the climate control system 10 may be operated to cool the conditioned space 18, so that the heat exchanger 130 may cool the airflow 20 via the heat transfer fluid 13. Conversely, in some embodiments (e.g., such as when the climate control system 10 is configured as or includes a heat pump), the climate control system 10 may be operated to heat the conditioned space 18 so that the heat exchanger 130 may heat the airflow 20 via the heat transfer fluid 13.

In some embodiments, the refrigeration assembly 12 may include or comprise a refrigerant circuit that is configured to circulate a refrigerant (e.g., hydrocarbons, fluorocarbons, hydrofluorocarbons, hydrochlorofluorocarbons, chlorofluorocarbons, ammonia, carbon dioxide, or some combination thereof) between a pair of heat exchangers (e.g., such as an evaporator and a condenser) to controllably change the phase of the refrigerant (e.g., between vapor and liquid) and thereby transfer heat between two mediums or spaces.

In some embodiments, the heat transfer fluid 13 may comprise the refrigerant so that the heat exchanger 130 may comprise a portion of the refrigerant circuit of refrigeration assembly 12 (in which case, the heat exchanger 130 may function either as an evaporator for the refrigerant when cooling the airflow 20 or as a condenser for the refrigerant when heating the airflow 20). Alternatively, in some embodiments, the heat transfer fluid 13 may be separate from the refrigerant circuit of the refrigeration assembly 12, and may instead comprise an additional, intermediary fluid circuit for transferring heat between the refrigerant of the refrigeration assembly 12 and the airflow 20 during operations. For instance (e.g., such as when climate control system 10 is configured as a chiller), the heat transfer fluid 13 may comprise a water (or other aqueous solution) that exchanges heat with the refrigerant in the refrigeration assembly 12 and with the airflow 20 via the heat exchanger 130 in the air handler 100. Specifically, in some embodiments, the heat transfer fluid 13 may comprise a chilled water circuit that is used to cool the airflow 20 via the heat exchanger 130 during operations.

A plurality of fan assemblies 150 are positioned in the enclosure 110 so as to drive the airflow 20 therethrough during operations. Each fan assembly 150 may include an air inlet 158, an impeller 156, and a motor 152. The motor 152 may drive rotation of the impeller 156 via a shaft 154 so as to draw the airflow 20 into the air inlet 158 and discharge the airflow 20 toward the heat exchanger 130. The motor 152 may be supported on a motor base 151, which may comprise any suitable based, frame, stand, or other structure(s) that are configured to support the motor 152 in place during operations.

In some embodiments, the motors 152 may be heavy so that additional equipment may be needed to lift and maneuver the motors 152 during installation or maintenance thereof. In addition, the available space within the enclosure 110 may be limited so that use of traditional lifting equipment such as cranes and separate lifting frames and winches may not be practical or feasible. Accordingly, the air handler 100 may include an overhead lifting beam or support 160 that may be used to lift and move motors 152 (and/or other components of a fan assembly 150) between their corresponding bases 151 and the access door 116. As will be described in more detail herein, the lifting beam 160 may have a plurality of lifting supports 162 defined or mounted thereon that are configured to support one or more lifting lines for efficiently lifting and laterally moving the motors 152 within the enclosure 110 during operations. The lifting supports 162 may comprise any suitable brackets, attachments points, lifting eyes, posts, wheels (e.g., pulleys, gears, sprockets, etc.) or any other suitable structure or component that may be used to support the weight of one of the motors 152 via suitable lifting lines (e.g., lifting lines 170, 172 described herein).

In the example embodiment shown in FIG. 1, the lifting beam 160 may be generally aligned with the access door 116 to facilitate maneuvering of the motors 152 toward and away from the access door 116. However, as shown in FIG. 1, aligning the lifting beam 160 with the access door 116 may also cause the lifting beam 160 to be laterally offset from the motors 152. Referring briefly to FIG. 2, in some embodiments, all or part of the lifting beam 160 may be positioned over (or substantially over) the motors 152 so as to help facilitate lifting and lowering the motors 152 vertically (or substantially vertically) relative to the corresponding motor base 151. In some of these embodiments (as shown in FIG. 2), the lifting beam 160 may have a general L-shape or configuration including a first portion 161 extending over the motors 152 and a second portion 163 extending at about 90° from the first portion 161 to the access door. The first portion 161 may include a plurality of lifting supports 162 as previously described for the embodiment of lifting beam 160 shown in FIG. 1. In addition, the lifting beam 160 shown in FIG. 2 may include at least one lifting support on the second portion 163 that may generally be aligned with and/or proximate the access door 116. As will be described in more detail herein, in some embodiments, the lifting beam 160 may be replaced with separate lifting supports (e.g., lifting supports 162) that are individually connected to and supported by the structure of the enclosure 110 (e.g., walls 112, ceiling 114, floor 115, etc.).

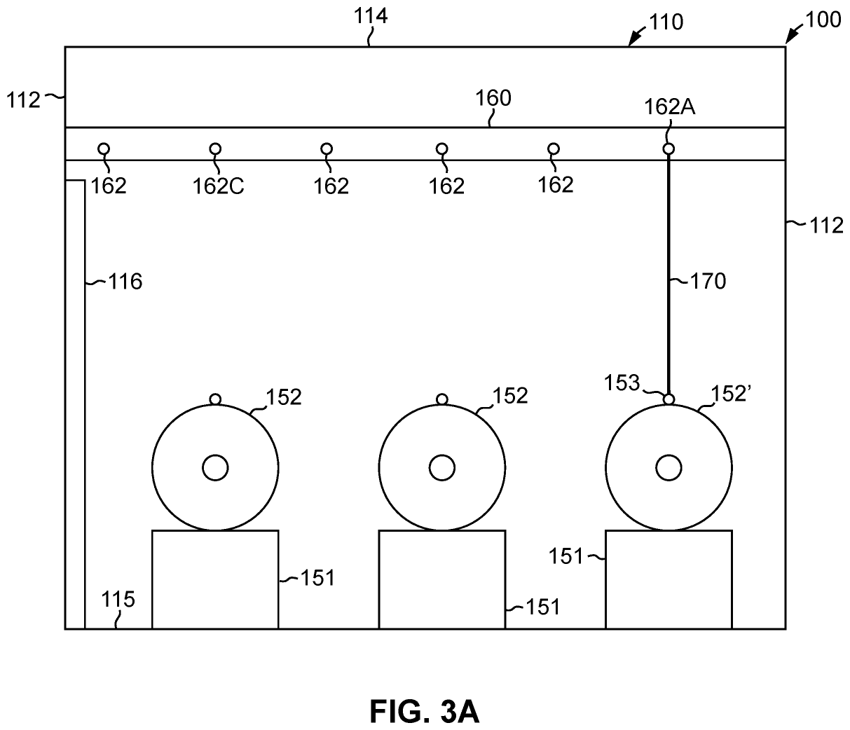

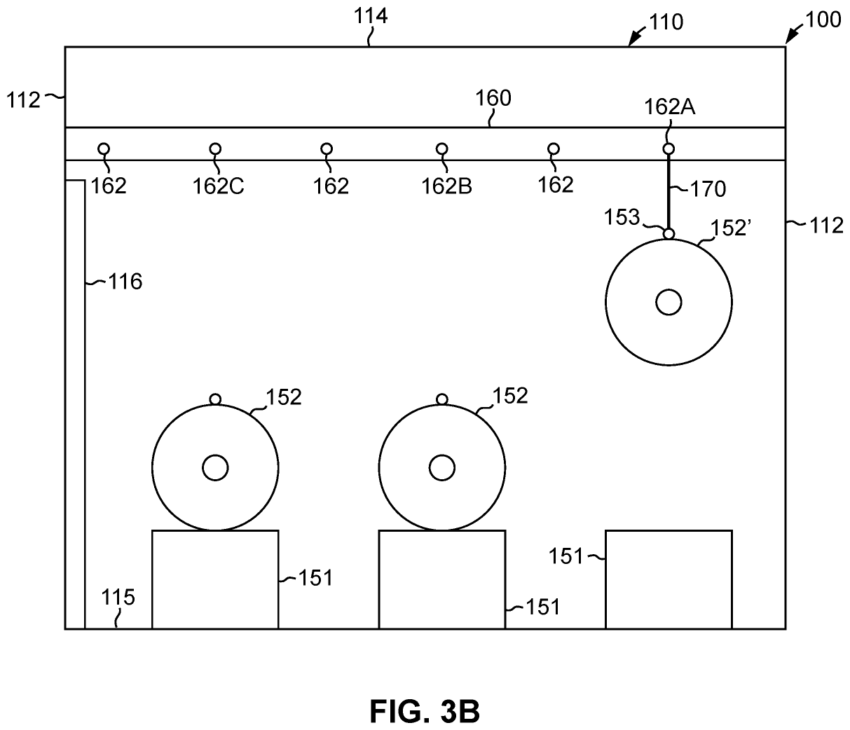

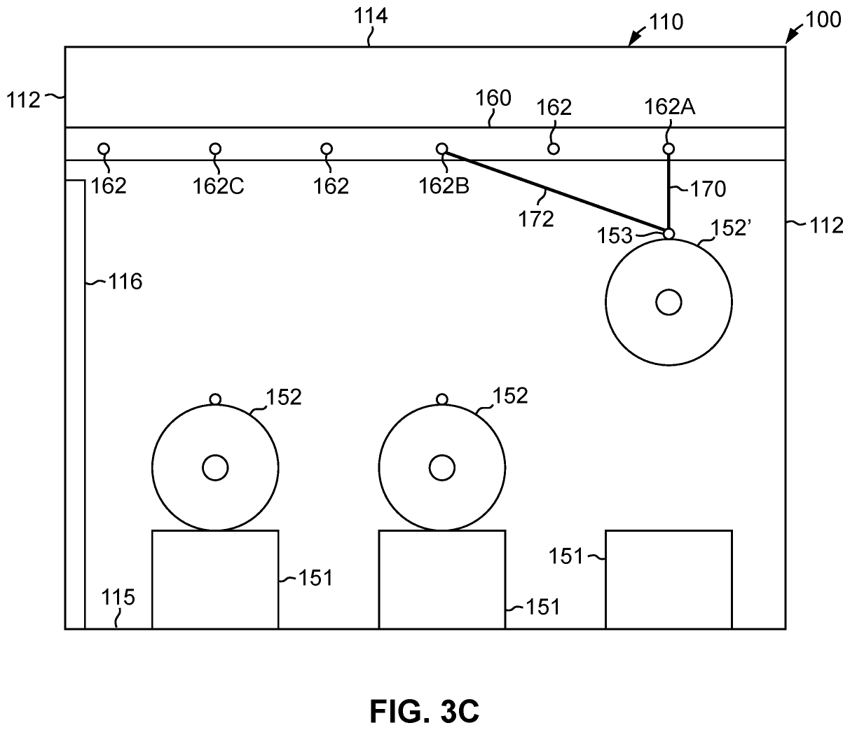

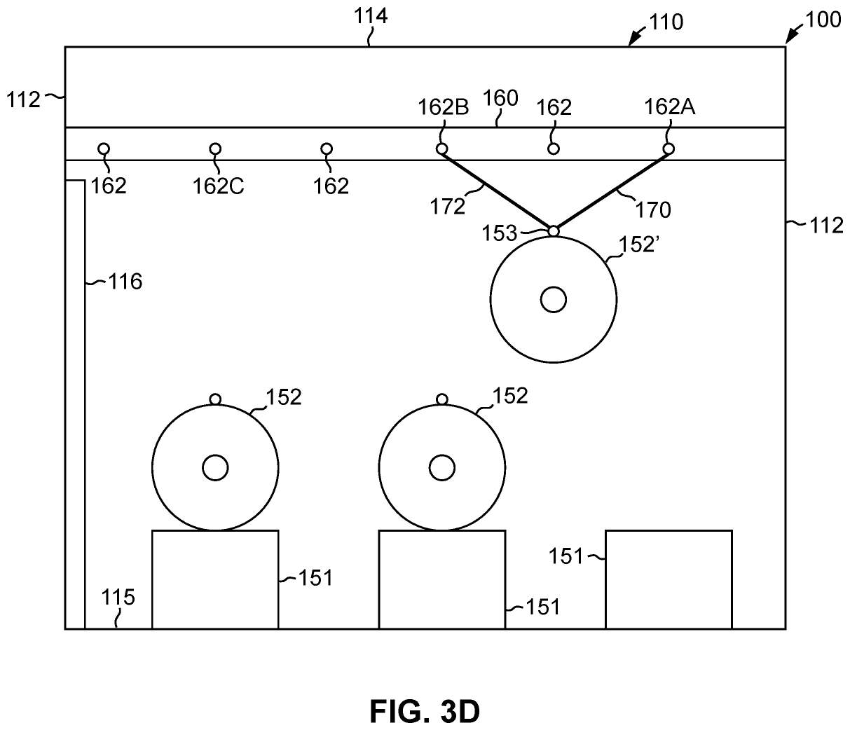

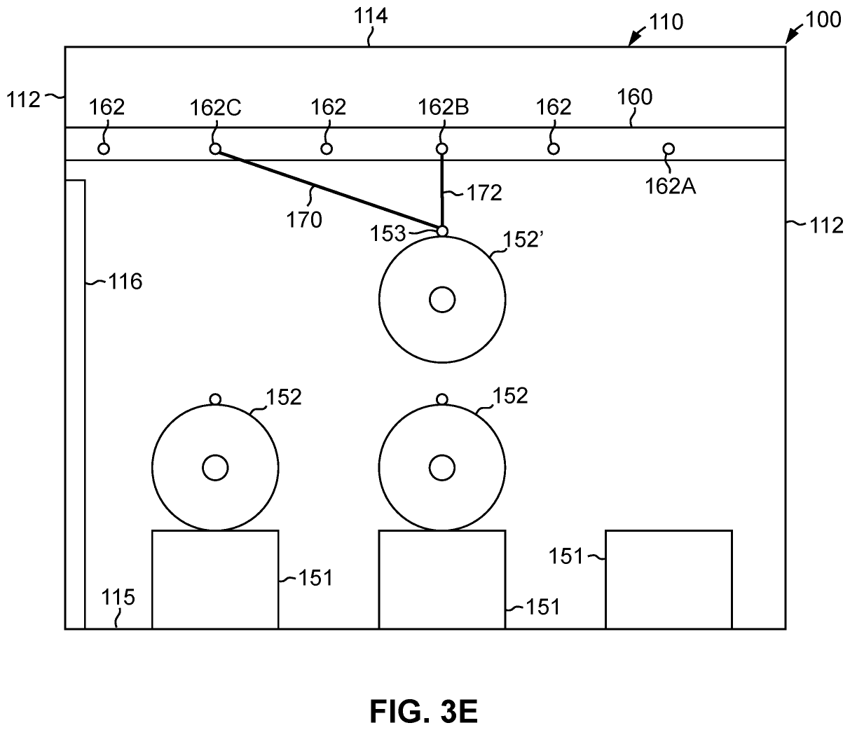

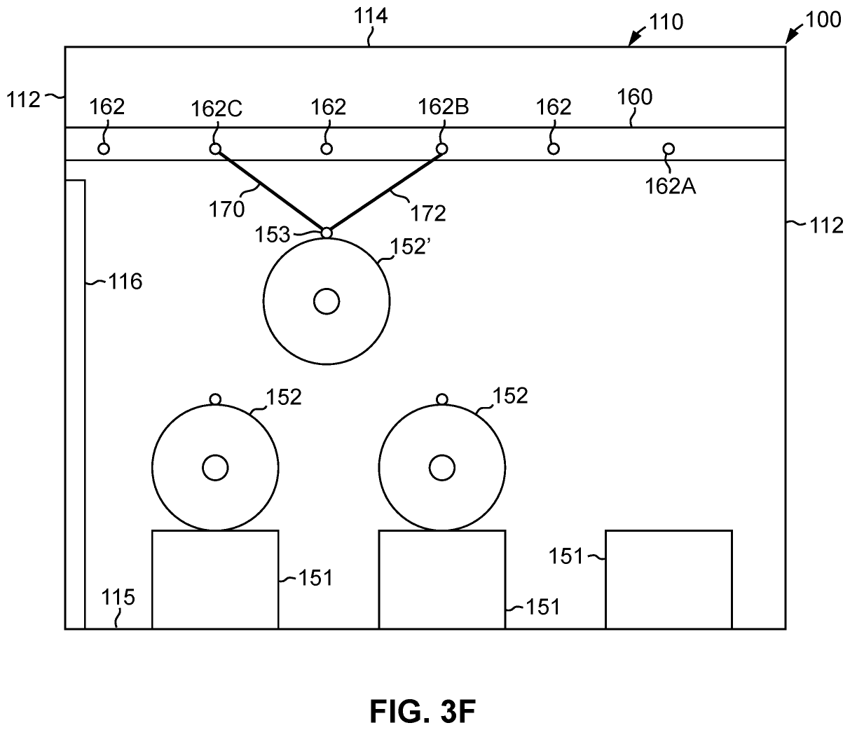

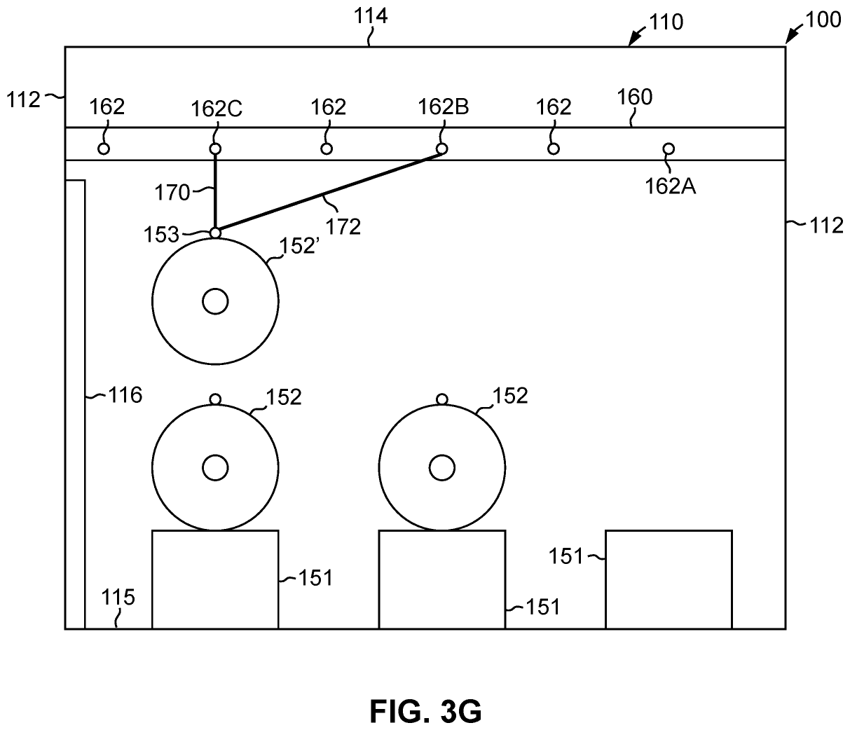

Referring now to FIGS. 3A-3G, a sequence of a process of lifting and moving one of the motors 152 within the enclosure 110 of the air handler 100 is shown according to some embodiments. As is described in more detail herein, the method shown in FIGS. 3A-3G may be accomplished by controllably paying in and paying out multiple lifting lines 170, 172 that are connected to corresponding ones of the lifting supports 162 on lifting beam 160 and the motor 152 so as to laterally traverse the motor 152 through the enclosure 110, between the door 116 and the corresponding motor base 151 with minimal equipment and additional infrastructure. The specific sequence shown in FIGS. 3A-3G illustrates a process of removing the motor 152 from the enclosure 110 (and thus moving the motor 152 from the corresponding motor base 151 to or toward the door 116); however, it should be appreciated that the process illustrated in FIGS. 3A-3G (and described herein) may also be utilized to move the motor 152 within the enclosure 110 for other purposes (e.g., to install the motor 152, move the motor 152 within the enclosure 110, etc.).

Initially, as shown in FIGS. 3A and 3B, one of the motors 152 (which is identified in FIGS. 3A-3G with reference number 152′) is lifted off of the corresponding motor base 151 by a first lifting line 170 connected to a first of the lifting supports 162 (which is identified in FIGS. 3A-3G with reference number 162A). The first lifting line 170 may comprise any suitable elongate tether that is configured to be placed in tension to lift and suspend the motor 152′ during operations. For instance, the first lifting line 170 may comprise a cable, chain, rope, strap, chord, or some combination thereof. The first lifting line 170 may be connected to the motor 152′ via a lifting eye 153 (or any other suitable lifting point) defined on or connected to the motor 152′.

In addition, the first lifting support 162A may be generally positioned above (or substantially above) the motor 152′ so that the lifting line 170 may lift the motor 152′ vertically (or substantially vertically) off the base 151. Referring briefly again to FIG. 2, as previously described, in some embodiments, the lifting beam 160 or individual lifting supports 162 may be at least partially positioned vertically above the motors 152 to facilitate substantially vertical lifting or lowering relative to the motor bases 151. However, referring briefly again to FIG. 1, in some embodiments the lifting beam 160 or individual lifting support 162 may be spaced from the motors so that that lifting or lowering of a motor 152 relative to the corresponding motor base 151 may include some lateral deviation via the lifting supports

As shown in the sequence from FIGS. 3A to 3B, the motor 152′ may be lifted off the motor base 151 by reducing a length of the first lifting line 170 extending between the first lifting support 162A and the motor 152′. Any suitable method of reducing the length of the first lifting line 170 may be used (e.g., a winch, pulley, come along, etc.), and further details of potential systems and methods are described in more detail herein. As a result, further details of the process of shortening or paying in the first lifting line 170 are omitted from this specific description for the sake of brevity.

As shown in FIGS. 3C and 3D, once the motor 152′ is suspended from the first lifting support 162A via the first lifting line 170, the motor 152′ may then be traversed laterally within the enclosure 110 by connecting a second lifting line 172 between the motor 152′ and a second one of the lifting supports 162 (which is identified in FIGS. 3A-3G with reference number 162B). The second lifting support 162B may be laterally spaced from the motor the first lifting support 162A along the support beam 160. As a result, as shown in FIG. 3C, when the second lifting line 172 is initially connected to the motor 152′ and second lifting support 162B, the second lifting support 162B may also be laterally spaced from the motor 152′. Because the process shown in FIGS. 3A-3G is configured to move the motor 152′ from the motor base 151 to the access door 116, the second lifting support 162B may be laterally closer to the access door 116 than the first lifting support 162A.

As shown in the sequence from FIG. 3C to FIG. 3D, once the motor 152′ is connected to each of the lifting supports 162A, 162B via the lifting lines 170, 172, respectively, lifting lines 170, 172 may be controllably lengthened and shortened, respectively, so as to laterally shift the motor 152′ away from the first lifting support 162A and toward the second lifting support 162B. Specifically, the first lifting line 170 may be lengthened or extended between the first lifting support 162A and the motor 152′ while the second lifting line 172 may be shortened between the second lifting support 162B and the motor 152′ so that the motor 152′ may be moved laterally within the enclosure 110. The lateral movement of the motor 152′ may continue until the motor 152′ is vertically aligned under the second lifting support 162B and thus has moved laterally between the lifting supports 162A, 162B.

Referring now to FIG. 3E, once the motor 152′ is vertically aligned under the second lifting support 162B, the first lifting line 170 may be disconnected from the first lifting support 162A. Thereafter, the first lifting line 170 (or another lifting line) maybe connected to the motor 152′ and a third of the lifting supports 162 (which is identified in FIGS. 3A-3G with reference numeral 162C). The third lifting support 162C may be laterally spaced from both the second lifting support 162B and the motor 152′, and once again may be laterally closer to the access door 116 than the second lifting support 162B. Thus, as shown in the sequence from FIG. 3E to FIG. 3F and then from FIG. 3F to FIG. 3G, after the motor 152′ is connected to the lifting supports 162B, 162C via the lifting lines 172, 170, respectively, the motor 152′ may once again be moved laterally by controllably lengthening and shortening the lifting lines 172, 170 in a similar manner to that described above when moving the motor 152′ between the lifting supports 162A, 162B. Specifically, the second lifting line 172 may be lengthened between the second lifting support 162B and the motor 152′ while the first lifting line 170 may be shortened between the third lifting support 162C and the motor 152′ so that the motor 152′ translates laterally between the lifting supports 162B, 162C.

The above-described process may be repeated a number of times using different pairs of the lifting supports 162 so as to ultimately traverse the motor 152′ across the enclosure 110 to the access door 116, from which personnel may maneuver the motor 152′ utilizing larger lifting components (e.g., independent cranes, winches, etc.) that may be positioned outside the enclosure 110.

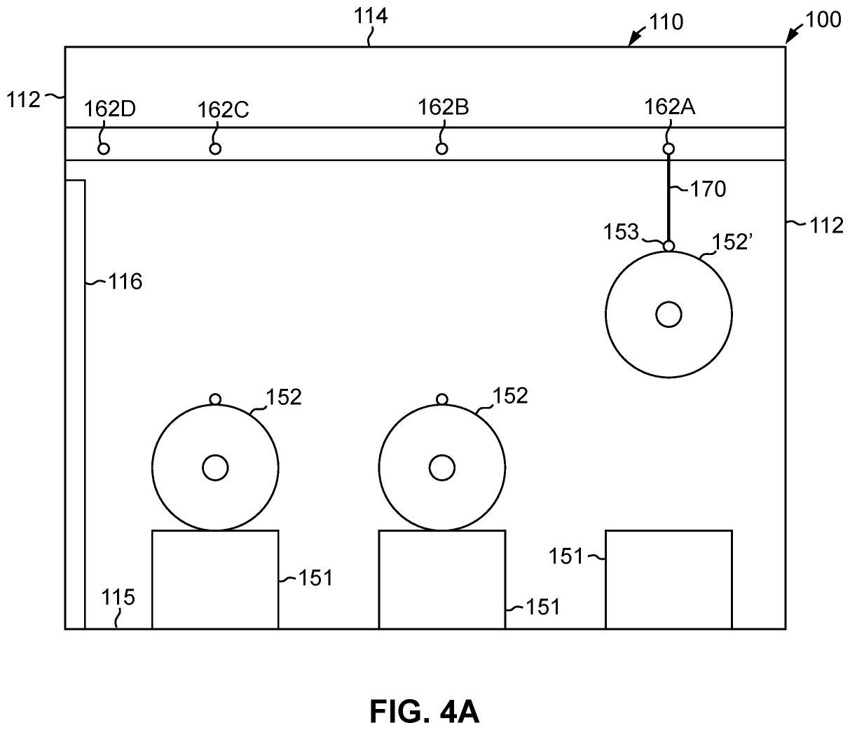

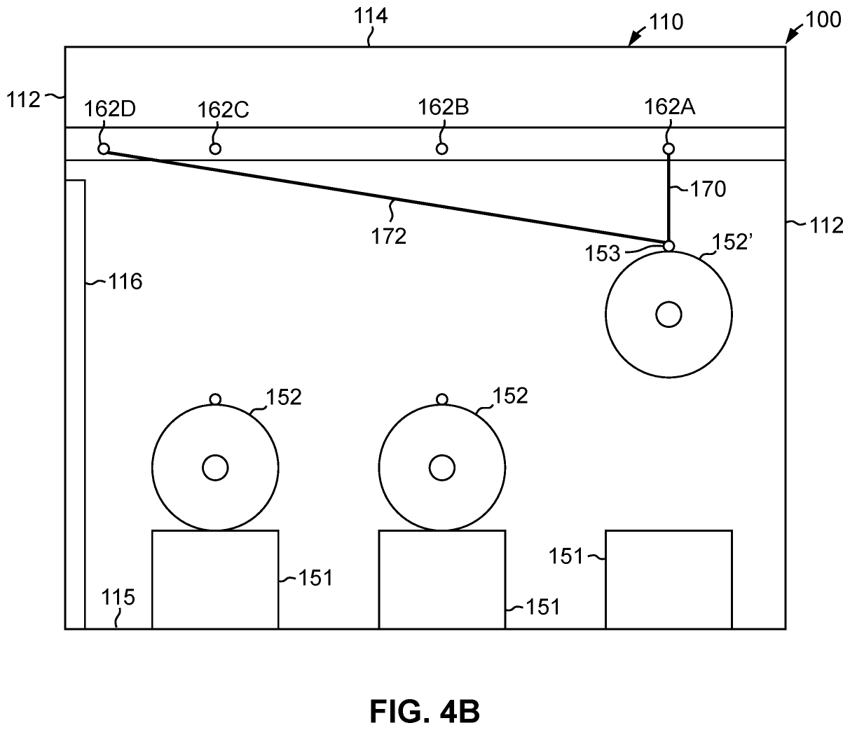

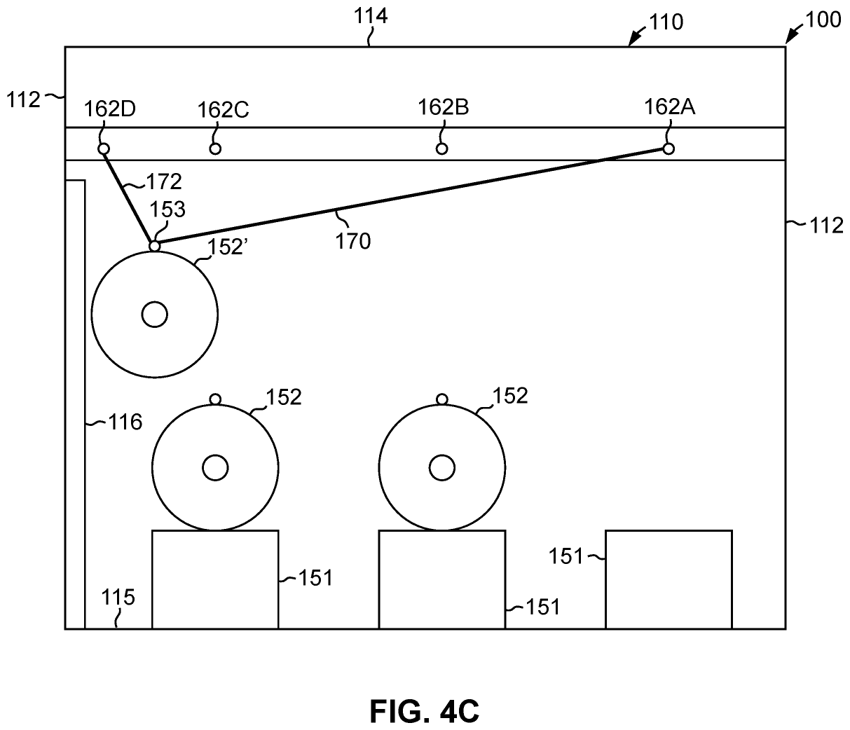

Thus, by selectively and controllably lengthening and shortening lifting lines (e.g., lifting lines 170, 172) from laterally spaced lifting supports 162, the motor 152′ may be laterally traversed across the enclosure 110 without the use of cumbersome cranes or other large lifting components such as overhead trolleys, which may not be usable in the confined space of the enclosure 110 and which may require more complex and/or expensive design and fabrication. It should be appreciated that the number of stages may be altered so that fewer or more lifting points and steps may be utilized to fully laterally translate the suspended motor 152′ across the enclosure. For instance, as shown in FIGS. 4A-4C, an alternative lifting process is shown in which motor 152′ is traversed across the entire enclosure 110 in a single stage by connecting to two lifting supports 162 along the lifting beam 160.

Specifically, as shown in FIG. 4A, the motor 152′ may initially be lifted by the first lifting line 170 connected to a first lifting support 162A that is substantially vertically aligned with the motor 152′ as previously described. Thereafter, as shown in sequence FIG. 4B, the second lifting line 172 is connected to the motor 152′ and another lifting support 162D that is positioned at or proximate to the access door 116. Thereafter, as shown in the sequence from FIG. 4B to FIG. 4C, the first lifting line 170 is lengthened between the motor 152′ and the first lifting support 162A and the second lifting line 172 is shortened between the motor 152′ and the lifting support 152D so as to move the motor 152′ laterally across the enclosure 110, from above the motor base 151 to the access door 116 in a single step. Without being limited to this or any other theory, the choice of the number of stages or steps for moving the motor 152′ across the enclosure 110 may be based on a number of factors, including, for instance, the weight of the motor, the total distance of travel for the motor 152′ to the access door 116, the length and/or tensile strength of the lines 170, 172, etc.

Referring briefly again to FIG. 2, as previously described, in some embodiments, the lifting beam 160 may by substantially L-shaped, having a first portion 161 that is aligned with the plurality of motors 152, and a second portion 163 that extends from the first portion 161 to (or proximate to) the access door 116. When moving a motor 152 between the access door 116 and one of the motor bases 151, the motor 152 may be moved, using the lifting lines 170, 172 via the methods shown in FIGS. 3A-3G and 4A-4C, between a lifting support 162 positioned on the first portion 161 and the at least one lifting support 162 positioned on the second portion 163 in order to move the motor 152 toward or away from the access door 116 during operations.

As previously described, the lifting lines 170, 172 used in the methods shown in FIGS. 3A-3G and 4A-4C may be lengthened or shortened using any suitable method or device in order to affect the lateral movement of the motor 152′ across the enclosure 110. For instance, the lifting lines 170, 172 may be lengthened or shortened via a manual or motorized device.

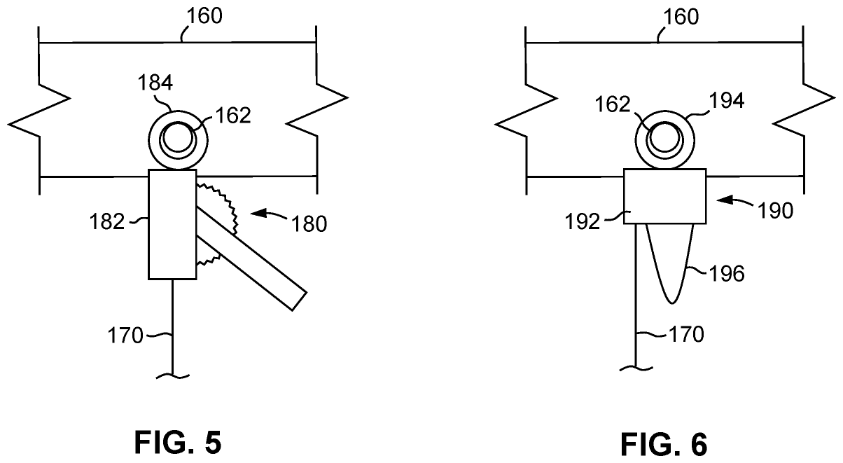

For example, FIGS. 5 and 6, show some embodiments of a manual winch that may be used to lengthen or shorten the lifting lines 170, 172 during the above-described lifting methods. Specifically, FIG. 5 shows a manual come-along 180 that includes a ratcheted handle assembly 182 that may be manually reciprocated by a user to either shorten or lengthen the corresponding lifting line (shown as the first lifting line in FIG. 5 as an example). The ratcheted handle assembly 182 includes a hook or eye 184 that may be engaged with the corresponding lifting support 162 (which is shown configured as a post or projection extending laterally outward from the lifting beam 160) during operations. The lifting line 170 (or lifting line 172) may be configured as a metal (e.g., steel) cable when a come-along or other similar ratcheting winch is used to controllably shorten or lengthen the lifting line during operations. In some embodiments, the lifting line may comprise a ratchet strap that is similarly adjustable (lengthwise) by actuating a ratcheting handle in a similar fashion to that described for the come along 180.

As another example, FIG. 6 shows a manual chain hoist 190 that includes a frame or body 192 that supports the lifting line (shown as the first lifting line 170 as an example). The lifting line 170 (or lifting line 172) may be configured as a length of chain when a chain hoist 190 is used to controllable shorten or lengthen the lifting line 170 during operations. The body 192 includes a hook or eye 194 that may be engaged with the corresponding lifting support 162 (which again is shown configured as a post or projection extending laterally outward from the lifting beam 160) during operations. An adjustment chain 196 may be coupled to the body 192. During operations, a user may manually pull on one side/leg of the adjustment chain 196 to shorten the lifting line 170 and may pull on the other, opposite side/leg of the lifting chain 196 to lengthen the lifting line 170.

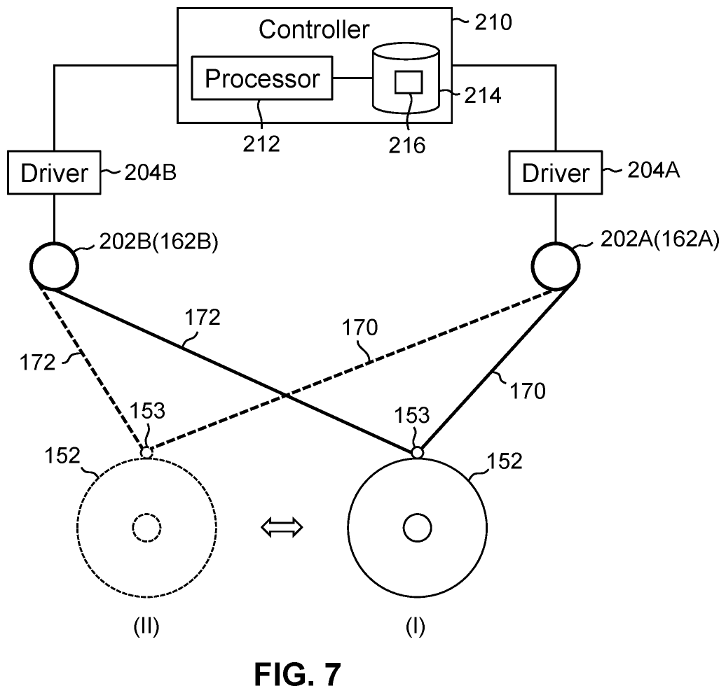

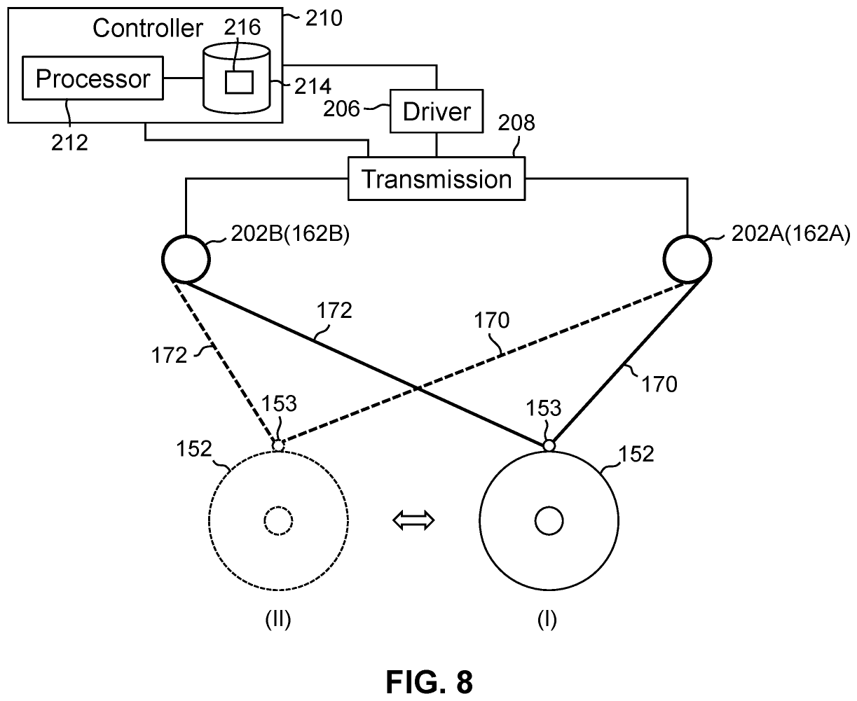

In some embodiments, one or more of the lifting lines 170, 172 may be lengthened or shortened using a motorized wheel in order to affect the lateral movement of the motor 152 across the enclosure 110. For instance, FIGS. 7 and 8 show examples where a pair of lifting supports 162A, 162B are or include wheels 202A, 202B connected to the lifting beam 160 (not shown) or other suitable structure(s) in the enclosure 110. The wheels 202A, 202B are configured to controllably pay out and pay in the first lifting line 170 and second lifting line 172, respectively, in order to laterally move or shift the motor 152. The wheels 202A, 202B may comprise pulleys, sprockets, gears, drums, or any other suitable wheel that may rotate to pay in or pay out a lifting line as described herein.

In the embodiment shown in FIG. 7, each of the wheels 202A, 202B may be independently driven by a separate driver 204A, 204B, respectively. The drivers 204A, 204B may comprise any suitable motor such as, for instance, electric motors, hydraulic motors, pneumatic motors, combustion engines, etc. In order to laterally shift the motor 152 from position (I) to position (II) (e.g., to the left) as shown in FIG. 7, the driver 204B may rotate the wheel 202B to pay in (and thereby shorten) the second lifting line 172, and the driver 204A may rotate the wheel 202A to pay out (and thereby lengthen) the first lifting line 170. Conversely, in order to laterally shift the motor 152 from position (II) to position (I) (e.g., to the right) as shown in FIG. 7, the driver 204B may rotate the wheel 202B to pay out (and thereby lengthen) the second lifting line 172, and the driver 204A may rotate the wheel 202A to pay in (and thereby shorten) the first lifting line 170. When moving the motor 152 between the positions (I) and (II) in FIG. 7, the lifting lines 170, 172 may be paid in and out at the same time or at different times; however, in either case the coordinated pay in and pay out of the lines 172, 170 causes the motor 152 to shift laterally between the positions (I) and (II).

In the embodiment shown in FIG. 8, each of the wheels 202A, 202B may be driven by a common driver 206 via a transmission 208. The driver 206 may comprise any suitable driver or motor, such as previously described herein for the drivers 204A, 204B. In addition, the transmission 208 may comprise any suitable device or system for transferring the output (e.g., rotational output) from the driver 206 to the wheels 202A, 202B. For instance, the transmission 208 may comprise one or more drive belts, gears, chains, pulleys, etc.

The transmission 208 may be configured to convert and transfer the output from driver 206 to drive suitable rotations of the wheels 202A, 202B to laterally shift the motor 152 between the positions (I) and (II). For instance, the transmission 208 may be configured to convert the output of driver 206 to pay out the first lifting line 170 from the first wheel 202A and also to pay in the second lifting line 172 from the second wheel 202B and thereby shift the motor 152 from the first position (I) to the second position (II) (or to the left) as shown in FIG. 8. Conversely, the transmission 208 may be configured to convert the output of driver 206 to pay out the second lifting line 172 from the second wheel 202B and also to pay in the first lifting line 170 from the first wheel 202A and thereby shift the motor 152 from the second position (II) to the first position (I) (or to the right) as shown in FIG. 8.

For both example embodiments shown in FIGS. 7 and 8, a controller 210 may be communicatively coupled (via any suitable wired and/or wireless connection) to the drivers 204A, 204B (FIG. 7) or drivers 206 (FIG. 8) so as to control the rotation of wheels 202A, 202B to laterally move the motor 152 as previously described. For instance, with respect to the example embodiment shown in FIG. 7, the controller 210 may control the rates of rotation of the wheels 202A, 202B via the drivers 204A, 204B, respectively, so that the motor 152 is moved laterally between the positions (I) and (II) without substantially any or with minimal vertical deviation.

Specifically, the controller 210, when moving the motor 152 from the first position (I) to the second position (II) (or to the left) as shown in FIG. 7, the controller 210 may initially rotate the first wheel 202A faster than the second wheel 202B via the drivers 204A and 204B, respectively, so as to pay out the first lifting line 170 from the first wheel 202A faster than the second lifting line 172 is paid into the second wheel 202B until the motor 152 has reached a substantial mid-point between the positions (I) and (II). Thereafter, the controller 210 may rotate the second wheel 202B faster than the first wheel 202A so as to pay in the second lifting line 172 into the second wheel 202B faster than the first lifting line 170 is paid out from the first wheel 202A and thereby to continue moving the motor 152 toward the second position (II). During these adjustments by the controller 210, the rotational rates of the wheels 202A, 202B may be constantly varied as the motor 152 is traversed laterally between the positions (I), (II). Specifically, when moving from the first position (I) to the second position (II), the second wheel 202B may have a rotational speed that is gradually increased along a continuous rate (e.g., a linearly varying rate), while the first wheel 202A may have a rotational speed that is gradually decreased along a continuous rate (e.g., another linearly varying rate). The varying rates of speed for the first wheel 202A and second wheel 202B may find a common point generally midway between the positions (I) and (II), when the lines 170, 172 are generally equally paid out from the wheels 202A, 202B, respectively.

The above-described differences in the rotational speed of the wheels 202A, 202B may allow the motor 152 to move in a substantially laterally direction without little, no (or substantially no) vertical deviation. As a result, during operations the motor 152 may be substantially maintained in a single laterally oriented plane (or lateral plane) when moving between the positions (I) and (II).

In addition, with respect to the example embodiment shown in FIG. 8, the controller 210 may control the rates of rotation of the wheels 202A, 202B to prevent or reduce vertical deviation of the motor 152 during movement between the positions (I) and (II) as previously described by controlling one or both of the driver 206 and transmission 208. For instance, the controller 210 may alter a rotational speed of the driver 206 and/or may adjust an output of the transmission 208 (e.g., via a change to gearing ratios, gear/belt selection, etc.) so as to controllably vary the rotational speeds of the wheels 202A, 202B as previously described for the embodiment shown in FIG. 7.

For both of the example embodiments of FIGS. 7 and 8, the controller 210 may adjust the speeds of the wheels 202A, 202B via the drivers 204A, 204B by tracking the rotations of the wheels 202A, 202B and based on the known dimensions of the system (e.g., the lateral distance between the wheels 202A, 202B and/or positions (I) and (II), the initial paid lengths of the lifting lines 170, 172, etc.). Thus, the controller 210 and/or the drivers 204A, 204B may comprise, include (or be communicatively coupled to), devices that are configured to track or detect the rotations or rotational positions of the wheels 202A, 202B (e.g., either directly or via the rotational positions of other components such as the drivers 204A, 204B, 206, one or more components of transmission 208, etc.). For instance, in some embodiments the drivers 204A, 204B shown in FIG. 7 (or similarly the driver 206 shown in FIG. 8) may comprise servo motors or stepper motors that are configured to provide an output to the controller 210 that is indicative of the rotational positions or number of rotations of the drivers 202A, 202B, which can then be used by the controller 210 to determine the position of the motor 152 at or between the positions (I) and (II) and thereby adjust the rotational speeds of the wheels 202A, 202B via drivers 204A, 204B accordingly in order to avoid or minimize vertical deviation of the motor 152 as previously described.

The controller 210 may comprise one or more computing devices, such as a computer, tablet, smartphone, server, circuit board, or other computing device(s) or system(s). Thus, controller 210 may include a processor 212 and a memory 214.

The processor 212 may include any suitable processing device or a collection of processing devices. In some embodiments, the processor 212 may include a microcontroller, central processing unit (CPU), graphics processing unit (GPU), timing controller (TCON), scaler unit, or some combination thereof. During operations, the processor 212 executes machine-readable instructions (such as machine-readable instructions 216) stored on memory 214, thereby causing the processor 212 to perform some or all of the actions attributed herein to the controller 210. In general, processor 212 fetches, decodes, and executes instructions (e.g., machine-readable instructions 216). In addition, processor 212 may also perform other actions, such as, making determinations, detecting conditions or values, etc., and communicating signals. If processor 212 assists another component in performing a function, then processor 212 may be said to cause the component to perform the function.

The memory 214 may be any suitable device or collection of devices for storing digital information including data and machine-readable instructions (such as machine-readable instructions 216). For instance, the memory 214 may include volatile storage (such as random-access memory (RAM)), non-volatile storage (e.g., flash storage, read-only memory (ROM), etc.), or combinations of both volatile and non-volatile storage. Data read or written by the processor 212 when executing machine-readable instructions 216 can also be stored on memory 214. Memory 214 may include “non-transitory machine-readable medium,” where the term “non-transitory” does not include or encompass transitory propagating signals.

The processor 212 may include one processing device or a plurality of processing devices that are communicatively coupled to one another (and potentially distributed in a variety of locations). Likewise, the memory 214 may include one memory device or a plurality of memory devices that are communicatively coupled to one another (and potentially distributed in a variety of locations). Thus, the controller 210 may comprise a plurality of individual “controllers” (e.g., such individual controllers that are coupled to the drivers 204A, 204B, transmission 208, driver 206, etc.).

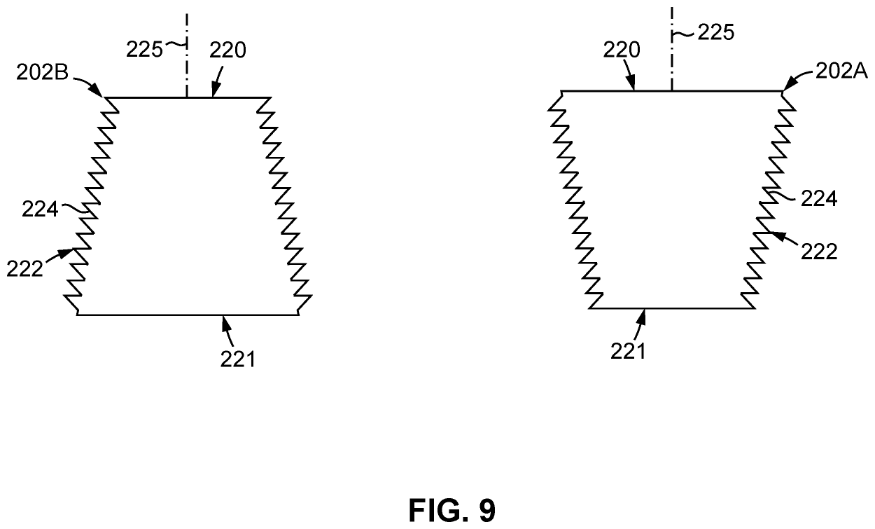

In some embodiments, the varying rates of speeds of pay in and pay out of the lifting lines 170, 172 may be accomplished via the mechanical structure of the wheels 202A, 202B (or other components such as the transmission 208 for the example embodiment shown in FIG. 8). For instance, as shown in FIG. 9, the wheels 202A, 202B may be conical in shape so as to affect different pay in and pay out rates of the lifting lines 170, 172 during the lateral movement of the motor 152 and for a constant rotational speed of the wheels 202A, 202B. Specifically, in the embodiment shown in FIG. 9, each of the wheels 202A, 202B includes a central or longitudinal axis 225 (or axis of rotation), a first or inner end 220 and a second or outer end 221 opposite the inner end 220. The inner end 220 may be closest or most proximate to the corresponding driving component of the wheel 202A, 202B (e.g., such as a corresponding one of the drivers 204A, 204B for the embodiment of FIG. 7, or a driving component of the transmission 208 for the embodiment shown in FIG. 8), and the outer end 221 may be farthest or most distal to the corresponding driving component.

In addition, each of the wheels 202A, 202B includes a radially outer surface 222 that extends between the ends 220, 221 generally along the axis 225. The radially outer surface 222 is tapered. Specifically, for the first wheel 202A, the radially outer surface 222 may generally taper radially inward (or radially toward the axis 225) when moving axially from the inner end 220 to the outer end 221, and for the second wheel 202B, the radially outer surface 222 may generally taper radially outward (or radially away from the axis 225) when moving axially from the inner end 220 to the outer end 221. For both wheels 202A, 202B a continuous helical groove 224 may be formed in the radially outer surface 222 that extends helically about the axis 225 between ends 220, 221. The grooves 224 of the wheels 202A, 202B may receive the corresponding lifting lines 170, 172 as the lifting lines 170, 172 are paid onto the corresponding wheels 202A, 202B during operations.

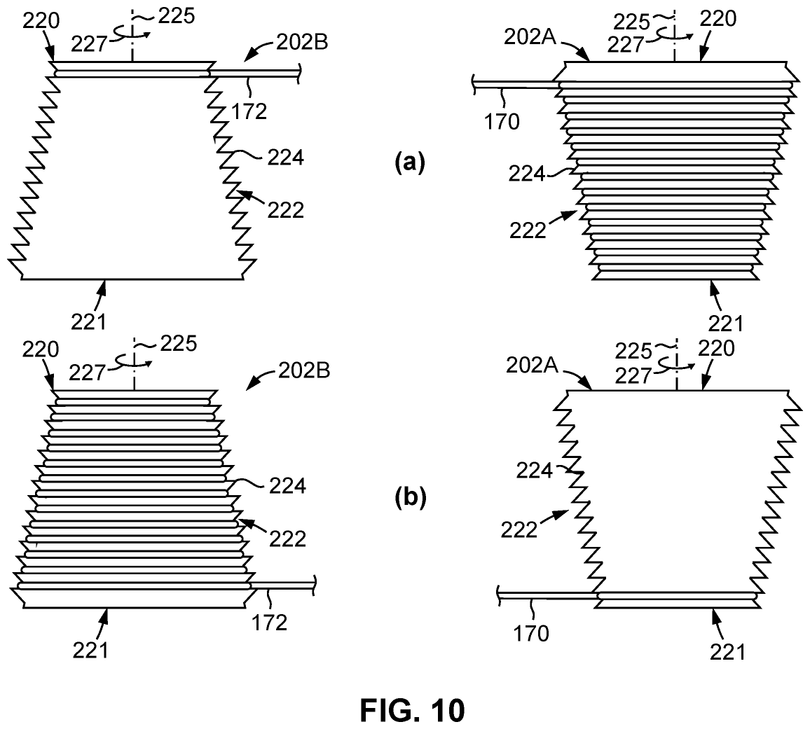

The tapered radially outer surfaces 222 of the wheels 202A, 202B may allow the lifting lines 170, 172 (FIGS. 7 and 8) to pay in and out at different rates relative to the wheels 202A, 202B as the wheels 202A, 202B are rotated about the corresponding axes 225 at a constant rotational speed. For instance, FIGS. 10(a) and 10(b) illustrate the lifting lines 170, 172 paid onto the wheels 202A, 202B when the motor 152 is at (or proximate to) the positions (I) and (II), respectively, in FIGS. 7 and 8 according to some embodiments.

As shown in FIG. 10(a), at the first position (I) in FIGS. 7 and 8, and as the wheels 202A, 202B rotate about the corresponding axes 225 in the direction 227, the first lifting line 170 and second lifting line 172 may be paid out/in from the grooves 224 of wheels 202A, 202B closer to the inner ends 220. As previously described, the radially outer surfaces 222 of the wheels 202A, 202B are tapered such that an outer diameter of the first wheel 202A may be larger at the inner end 220 than at the outer end 221, while an outer diameter of the second wheel 202B may be smaller at the inner end 220 than at the outer end 221. As a result, during movement from the first position (I) (FIGS. 7 and 8) to the second position (II), the initial pay out of the first lifting line 170 from the first wheel 202A may be faster than the initial pay in of the second lifting line 172 on the second wheel 202B.

Conversely, as shown in FIG. 10(b), at the second position (II) in FIGS. 7 and 8, and as the wheels 202A, 202B continue to rotate about the corresponding axes 225 in the direction 227, the first lifting line 170 and second lifting line 172 may be paid out from the grooves 224 of wheels 202A, 202B closer to the outer ends 221. As previously described, the radially outer surfaces 222 of the wheels 202A, 202B are tapered such that an outer diameter of the first wheel 202A may be smaller at the outer end 221 than at the inner end 220, while an outer diameter of the second wheel 202B may be larger at the outer end 221 than at the inner end 221. As a result, during movement from the first position (I) (FIGS. 7 and 8) to the second position (II), as the motor 152 approaches the second position (II) the pay out of the first lifting line 170 from the first wheel 202A may be slower than the pay in of the second lifting line 172 onto the second wheel 202B. Moreover, the diameters of the wheels 202A, 202B may be generally equal at a mid-point or middle portion of the wheels 202A, 202B between the corresponding ends 220, 221, so that the pay out and pay in of the lifting lines 170 and 172, respectively, may be generally at the same rate at the mid-point between the positions (I), (II). As previously described, these relative changes in the pay in and pay out rates of the lifting lines 170, 172 from the wheels 202A, 202B may be configured to move the motor 152 laterally between the positions (I) and (II) with out or with minimal vertical deviation. However, by configuring the wheels 202A, 202B to have the tapered outer diameter as shown in FIGS. 9 and 10 and described herein, the varied rates of pay for the lifting lines 170, 172 relative to the wheels 202A, 202B may be achieved with a constant rotational speed of the wheels 202A, 202B about the axes 225 (e.g., in the rotational direction 227 shown in FIGS. 10(a) and 10(b)).

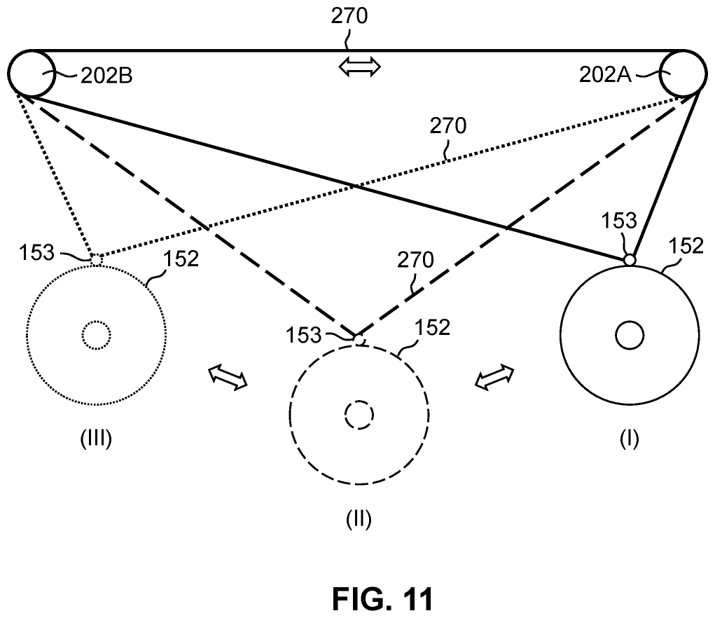

Referring now to FIG. 11, in some embodiments, a single, continuous lifting line 270 may be coupled to each of the pair of wheels 202A, 202B and the motor 152 (or more particularly the lifting eye 153) so that a rotation of the wheels 202A, 202B may translate the motor between the position (I), (II), (III). Specifically, in the example embodiment shown in FIG. 11, the wheels 202A, 202B may comprise gears or sprockets, and the continuous lifting line 270 may comprise a chain or geared belt. As a result, rotation of the wheels 202A, 202B may advance the lifting line 270 over the wheels 202A, 202B to thereby laterally move the motor 152 between the positions (I), (II), (III).

Specifically, rotating the wheels 202A, 202B so as to further circulate the lifting line 270 in a generally “clockwise” rotation as shown in the view of FIG. 11 may cause the motor 152 to advance from the first position (I) to the second position (II) and ultimately to the third position (III). Conversely, rotating the wheels 202A, 202B so as to further circulate the lifting line 270 in a generally “counter clockwise” rotation as shown in the view of FIG. 11 may cause the motor 152 to advance from the third position (III) to the second position (II) and ultimately the first position (I).

Because the rotation of the wheels 202A, 202B and the general advance of the lifting line 270 over the wheels 202A, 202B is synchronized in the embodiment shown in FIG. 11, the motor 152 may tend to deviate vertically as it moves laterally between the positions (I), (II), (III). Specifically, when the motor 152 is at the second position (II), which is midway between the first position (I) and the third position (III) in FIG. 11, the motor 152 may be vertically lower than when the motor 152 is positioned at either the first position (I) or the third position (III).

In the example embodiment of FIG. 11, a single driver (e.g., driver 206, 204A, 204B, etc.) may be used to drive the rotation of one or both of the wheels 202A, 202B to traverse the motor 152 laterally between the positions (I), (II), (III). Alternatively, in some embodiments, each of the wheels 202A, 202B may be rotated by a different driver (e.g., drivers 204A, 204B shown in FIG. 7) to traverse the motor 152 laterally between the positions (I), (II), (III). Without being limited to this or any other theory, use of a single, continuous lifting line 270 may simplify the control and operation of the system for laterally traversing the motor 152 across the enclosure 110 (FIGS. 1 and 2) by reducing the number of lifting lines and independent lifting points.

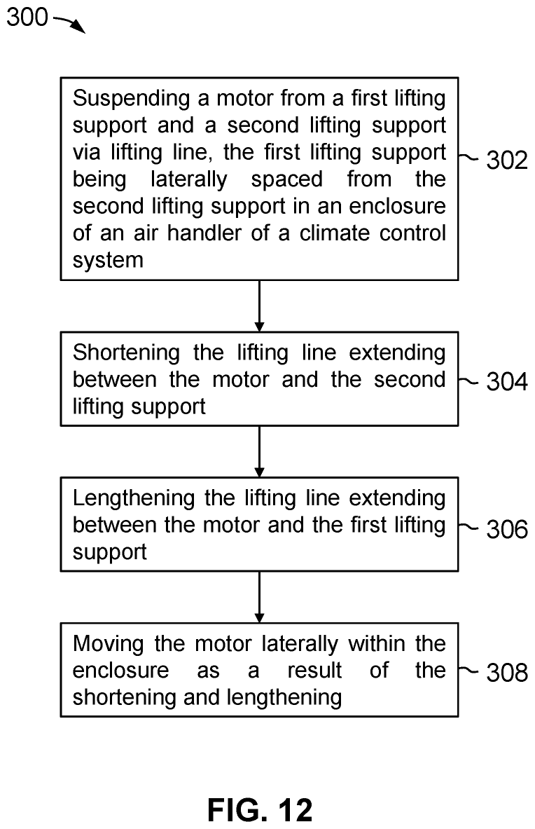

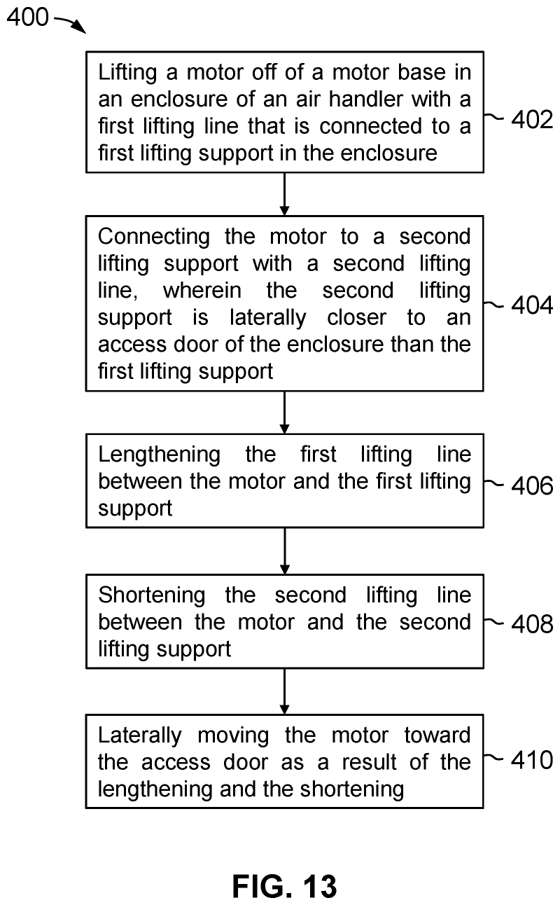

FIGS. 12 and 13 illustrate methods 300, 400 of moving a motor within an enclosure of an air handler according to some embodiments disclosed herein. In some embodiments, the methods 300, 400 may be practiced using the systems and features shown in FIGS. 1-11 and described herein. Thus, continuing reference is made to FIGS. 1-11 when describing the features of methods 300, 400 in FIGS. 12 and 13. However, such reference should not be interpreted as limiting the systems that may be used to practice the methods 300, 400. As a result, methods 300, 400 may be practiced using system that differ in at least some respects from those shown in FIGS. 1-11 and/or described herein.

Referring first to FIG. 12, initially method 300 includes suspending a motor from a first lifting support and second lifting support via lifting line at block 302. The first lifting support is laterally spaced from the second lifting support in an enclosure of an air handler of a climate control system. For instance, as shown in FIGS. 3A-3G, a motor 152′ may be suspended from lifting line 170, 172 that is connected to a pair of lifting supports 162 that are laterally spaced from one another in the enclosure 110. The lifting supports may comprise any suitable frame, bracket, eyelet, post, winch wheel (e.g., pulley, sprocket, gear, etc.) that is configured to support a tensioned lifting line (e.g., rope, cable, chain, etc.) for suspending another object (e.g., such as a motor 152).

In addition, method 300 includes shortening the lifting line extending between the motor and the second lifting support at block 304, and lengthening the lifting line extending between the motor and the first lifting support at block 306. The shortening and lengthening at blocks 304 and 306, respectively, may be performed at least partially at the same time or may be performed at different times (e.g., sequentially).

In some embodiments, the lifting line may comprise a first lifting line extending between the motor and the first lifting support (e.g., such as the first lifting line 170 shown in FIGS. 3C extending between the motor 152′ and the first lifting support 162A) and a second lifting line extending between the motor and the second lifting support (e.g., such as the second lifting line 172 shown in FIG. 3C extending between the motor 152′ and the second lifting support 162B). Thus, shortening the lifting line at block 304 may comprise shortening (e.g., via a winch, wheel, etc.) the second lifting line between the motor and the second lifting support, and lengthening the lifting line at block 306 may comprise extending (e.g., again via winch, wheel, etc.) the first lifting line between the motor and the first lifting support.

In some embodiments, the lifting line may comprise a continuous lifting line that is connected to each of the first lifting support, the second lifting support, and the motor (e.g., such as is the case for lifting line 270 shown in FIG. 11). In addition, the first lifting support and the second lifting support may comprise first and second wheels (e.g., pulleys, gears, sprockets, etc.). Thus, shortening the lifting line at block 304 and lengthening the lifting line at block 306 may comprise rotating the first wheel (first lifting support) and the second wheel (second lifting support) to shorten the length of the lifting line extending between the second lifting support and the motor and increasing the length of the lifting line extending between the first lifting support and the motor.

Referring still to FIG. 12, method 300 also includes, at block 308, moving the motor laterally within the enclosure as a result of the shortening and lengthening in blocks 304 and 306, respectively. For instance, as previously described and shown in FIGS. 3A-3G, 4A-4C, 7, 8, 11, lengthening the lifting line (e.g., first lifting line 170, lifting line 270) between the motor (e.g., motor 152) and the first lifting support (e.g., lifting support 162A) and shortening the lifting line between the motor and the second lifting support (e.g., lifting support 162B) may laterally traverse the motor between the lifting supports and thus laterally within the enclosure (e.g., enclosure 110).

Referring now to FIG. 13, initially method 400 includes, at block 402, lifting a motor off of a motor base in an enclosure of an air handler with a first lifting line that is connected to a first lifting support in the enclosure. For instance, as shown in FIGS. 3A and 4A, the motor 152′ may initially be lifted off of the corresponding motor base by a first lifting line 170 that is connected to a first lifting support 162A in the enclosure.

In addition, method 400 includes connecting the motor to a second lifting support with a second lifting line at block 404. The second lifting support may be positioned laterally closer to an access door of the enclosure than the first lifting support, such that the first lifting support and the second lifting support may be laterally spaced from one another in the enclosure. For instance, as shown in FIGS. 3B and 4B, after the motor 152′ is lifted off of the motor base 151 via the first lifting line 170, a second lifting line 172 is connected between the motor 152′ and a second lifting support 162B that is laterally spaced from the first lifting support 162A so that the second lifting support 162B is closer to the access door 116.

Further, method 400 includes lengthening the first lifting line between the motor and the first lifting support at block 406 and shortening the second lifting line between the motor and the second lifting support at block 408, and laterally moving the motor toward the access door at block 410. Blocks 406, 408, 410 may be similar to blocks 304, 306, 308 in method 300 (FIG. 12). Thus, in some embodiments, blocks 406, 408, 410 may include shortening (e.g., via a winch, wheel, etc.) the second lifting line between the motor and the second lifting support, and extending (e.g., again via winch, wheel, etc.) the first lifting line between the motor and the first lifting support, to thereby laterally move the motor between the first lifting support and the second lifting support in the enclosure.

As previously described, in some embodiments, the lifting beam 160 may be omitted (or substantially shortened) and one or more of the lifting supports 162 may be directly and individually supported via the structure of the enclosure 110 (e.g., walls 112, ceiling 114, floor 115, etc.). Without being limited to this or any other theory, a continuous lifting beam that spans all or part of the enclosure 110 may require additional construction and support framing within and about the enclosure 110. Thus, shortening or avoiding the lifting beam 160 may simplify the construction of the enclosure 110.

Embodiments disclosed herein include systems and methods for moving safely and efficiently moving a fan motor within the confined space of an enclosure of an air handler of a climate control system. In some embodiments, the systems and methods described herein may include controlled and coordinated lengthening and shortening of lengths of lifting lines connected to laterally spaced lifting supports within the enclosure so as to laterally traverse and maneuver the fan motor while minimizing uncontrolled movements (e.g., swinging). Thus, through use of the embodiments disclosed herein, a fan motor may be efficiently and safely moved about the limited space of an enclosure of climate control system air handler module with minimal additional infrastructure.

While specific embodiments described herein are directed to moving a motor within an enclosure of an air handler of a climate control system, it should be appreciated that the embodiments disclosed herein may be used to lift and move other objects from overheard supports. For instance, in some embodiments, the processes and methods described herein may be utilized to lift other components, assemblies, systems, etc. within or about the air handler 100, such as, for instance, components of one of the fan assemblies 150 (FIG. 1) including the air inlet 158, impeller 156, a motor 152 or any combination thereof. In addition, embodiments of the processes and methods described herein may be generally used to move heavy objects laterally between spaced overhead lifting supports with minimal infrastructure, both for other components or systems of a climate control system, and even for applications that are outside of air handlers or climate control systems entirely.

As explained above and reiterated below, the present disclosure includes, without limitation, the following example implementations.

Clause 1: A method of moving a motor within an enclosure of an air handler of a climate control system, the method comprising: (a) suspending the motor from a first lifting support and a second lifting support via lifting line, the first lifting support being laterally spaced from the second lifting support in the enclosure; (b) shortening the lifting line extending between the motor and the second lifting support; (c) lengthening the lifting line extending between the motor and the first lifting support; and (d) moving the motor laterally within the enclosure as a result of (b) and (c).

Clause 2: The method of any of the clauses, wherein the lifting line comprises a continuous lifting line that extends between the motor, the first lifting support, and the second lifting support.

Clause 3: The method of any of the clauses, wherein the first lifting support comprises a first wheel and the second lifting support comprise a second wheel, wherein (b) and (c) comprise rotating the first wheel and the second wheel.

Clause 4: The method of any of the clauses, wherein (b) and (c) comprise rotating at least one of the first wheel and the second wheel with a driver.

Clause 5: The method of any of the clauses, wherein the continuous lifting line comprises a chain, and wherein at least one of the first wheel and the second wheel comprises a sprocket.

Clause 6: The method of any of the clauses, wherein the lifting line comprises a first lifting line and a second lifting line, and wherein (a) comprises: (a1) connecting the motor to the first lifting support with the first lifting line; and (a2) connecting the motor to the second lifting support with the second lifting line.

Clause 7: The method of any of the clauses, wherein either (b) or (c) further comprises changing a length of the first lifting line or the second lifting line, respectively, by use of a manual winch.

Clause 8: The method of any of the clauses, wherein the manual winch is selected from the group consisting of a come-along, a chain hoist, or a ratchet.

Clause 9: The method of any of the clauses, wherein either (b) or (c) further comprises further comprises changing a length of the first lifting line or the second lifting line, respectively, by use of a driver.

Clause 10: The method of any of the clauses, wherein the first lifting support comprises a first wheel and the second lifting support comprises a second wheel, wherein (b) comprises paying the second lifting line into the second wheel; and wherein (c) comprises paying the first lifting line out from the first wheel.

Clause 11: The method of any of the clauses, wherein (b) comprises paying the second lifting line into the second wheel at a first rate, and wherein (c) comprise paying the first lifting line out from the first wheel at a second rate, the second rate being different from the first rate.

Clause 12: The method of any of the clauses, wherein (d) comprises substantially maintaining the motor in a lateral plane while moving the motor laterally within the enclosure.

Clause 13: A method of removing a motor from an enclosure of an air handler of a climate control system, the method comprising: (a) lifting the motor off of a motor base in the enclosure with a first lifting line that is connected to a first lifting support in the enclosure; (b) connecting the motor to a second lifting support with a second lifting line after (a), wherein the second lifting support is laterally closer to an access door of the enclosure than the first lifting support; (c) lengthening the first lifting line between the motor and the first lifting support; (d) shortening the second lifting line between the motor and the second lifting support; and (e) laterally moving the motor toward the access door as a result of (c) and (d).

Clause 14: The method of any of the clauses, wherein either (b) or (c) further comprises changing a length of the first lifting line or the second lifting line, respectively, by use of a manual winch.

Clause 15: The method of any of the clauses, wherein the manual winch is selected from the group consisting of a come-along, a chain hoist, or a ratchet.

Clause 16: The method of any of the clauses, wherein (d) comprises shortening the second lifting line between the motor and the second lifting support during (c).

Clause 17: The method of any of the clauses, further comprising substantially maintaining the motor in a lateral plane during (e).

Clause 18: The method of any of the clauses, wherein (c) comprises lengthening the first lifting line between the motor and the first lifting support at a first rate, wherein (d) comprises shortening the second lifting line between the motor and the second lifting support at a second rate, wherein the first rate and the second rate are different.

Clause 19: The method of any of the clauses, wherein the first lifting support comprises a first wheel and the second lifting support comprises a second wheel, wherein (c) comprises rotating the first wheel at a first rotational speed, and wherein (d) comprises rotating the second wheel at a second rotational speed, wherein the first rotational speed and the second rotational speed are equal.

Clause 20: The method of any of the clauses, wherein the first wheel and the second wheel each comprise a tapered wheel having a continuous helical groove formed thereon.

The preceding discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the discussion herein and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis. Further, when used herein (including in the claims), the words “about,” “generally,” “substantially,” “approximately,” and the like, when used in reference to a stated value mean within a range of plus or minus 10% of the stated value.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method of moving a motor within an enclosure of an air handler of a climate control system, the method comprising:
(a) suspending the motor from a first lifting support and a second lifting support via lifting line, the first lifting support being laterally spaced from the second lifting support in the enclosure;
(b) shortening the lifting line extending between the motor and the second lifting support;
(c) lengthening the lifting line extending between the motor and the first lifting support; and
(d) moving the motor laterally within the enclosure as a result of (b) and (c).

2. The method of claim 1, wherein the lifting line comprises a continuous lifting line that extends between the motor, the first lifting support, and the second lifting support.

3. The method of claim 2, wherein the first lifting support comprises a first wheel and the second lifting support comprise a second wheel, wherein (b) and (c) comprise rotating the first wheel and the second wheel.

4. The method of claim 3, wherein (b) and (c) comprise rotating at least one of the first wheel and the second wheel with a driver.

5. The method of claim 4, wherein the continuous lifting line comprises a chain, and wherein at least one of the first wheel and the second wheel comprises a sprocket.

6. The method of claim 1, wherein the lifting line comprises a first lifting line and a second lifting line, and wherein (a) comprises:
(a1) connecting the motor to the first lifting support with the first lifting line; and
(a2) connecting the motor to the second lifting support with the second lifting line.

7. The method of claim 6, wherein either (b) or (c) further comprises changing a length of the first lifting line or the second lifting line, respectively, by use of a manual winch.

8. The method of claim 7, wherein the manual winch is selected from the group consisting of a come-along, a chain hoist, or a ratchet.

9. The method of claim 6, wherein either (b) or (c) further comprises further comprises changing a length of the first lifting line or the second lifting line, respectively, by use of a driver.

10. The method of claim 6, wherein the first lifting support comprises a first wheel and the second lifting support comprises a second wheel,
wherein (b) comprises paying the second lifting line into the second wheel; and
wherein (c) comprises paying the first lifting line out from the first wheel.

11. The method of claim 10, wherein (b) comprises paying the second lifting line into the second wheel at a first rate, and wherein (c) comprise paying the first lifting line out from the first wheel at a second rate, the second rate being different from the first rate.

12. The method of claim 11, wherein (d) comprises substantially maintaining the motor in a lateral plane while moving the motor laterally within the enclosure.

13. A method of removing a motor from an enclosure of an air handler of a climate control system, the method comprising:
(a) lifting the motor off of a motor base in the enclosure with a first lifting line that is connected to a first lifting support in the enclosure;
(b) connecting the motor to a second lifting support with a second lifting line after (a), wherein the second lifting support is laterally closer to an access door of the enclosure than the first lifting support;
(c) lengthening the first lifting line between the motor and the first lifting support;
(d) shortening the second lifting line between the motor and the second lifting support; and
(e) laterally moving the motor toward the access door as a result of (c) and (d).

14. The method of claim 13, wherein either (b) or (c) further comprises changing a length of the first lifting line or the second lifting line, respectively, by use of a manual winch.

15. The method of claim 14, wherein the manual winch is selected from the group consisting of a come-along, a chain hoist, or a ratchet.

16. The method of claim 13, wherein (d) comprises shortening the second lifting line between the motor and the second lifting support during (c).

17. The method of claim 16, further comprising substantially maintaining the motor in a lateral plane during (e).

18. The method of claim 16, wherein (c) comprises lengthening the first lifting line between the motor and the first lifting support at a first rate, wherein (d) comprises shortening the second lifting line between the motor and the second lifting support at a second rate, wherein the first rate and the second rate are different.

19. The method of claim 18, wherein the first lifting support comprises a first wheel and the second lifting support comprises a second wheel, wherein (c) comprises rotating the first wheel at a first rotational speed, and wherein (d) comprises rotating the second wheel at a second rotational speed, wherein the first rotational speed and the second rotational speed are equal.

20. The method of claim 19, wherein the first wheel and the second wheel each comprise a tapered wheel having a continuous helical groove formed thereon.
